(19) United States
(12) Patent Application Publication
(10) Pub. No.: US 2011/0138974 A1
(43) Pub. Date: Jun. 16, 2011

(54) Hand tool having exchangeable tool bits

(76) Inventor: Yavuz Arslan, Barsbuettel (DE)

(21) Appl. No.: 12/654,232

(22) Filed: Dec. 15, 2009

(51) Int. Cl. B25B 15/02; B25B 23/00

(52) U.S. Cl. 81/440

(57) ABSTRACT

A hand tool includes base member having a front hole and a rear hole, a rack mounted in the base member, a tool bit holder set in the rack and rotatable relative to the rack to selectively shift one of a set of tool bit stored in tool bit holes thereof into axial alignment between the front hole and the rear hole of the base member, a tool bit connector mounted in the front side of the base member and having a tool bit outlet kept in axial alignment with the front hole of the base member, a grip having a front push rod axially slidably inserted into the rear hole of the base member and movable with the grip relative to the base member to push one the tool bit out of the tool bit holder into the tool bit outlet of the tool bit connector for working, and a retaining ring supported on a spring member inside the base member to guide sliding movement of the push rod relative to the base member and to prohibit falling of the push rod out of the base member.

### BACKGROUND OF THE INVENTION

1. Field of the Invention

The present invention relates to hand tools and more particularly, to a hand tool having exchangeable tool bits.

2. Description of the Related Art

Different hand tools may be used in different conditions for different purposes. There are known hand tools with a tool bit connector at the front side for holding one of a set of tool bits so that the user can selectively attach different tool bits to the tool bit connector subject to different working requirements. However, a tool box may be necessary for keeping a set of tool bits. It is still not convenient to use a hand tool that allows replacement of the tool bit. Further, the tool bits may be lost easily. There are commercial hand tools that have a hollow tool handle with tool bit storage means therein for keeping different tool bits. However, when changing the tool bit, the user must open the hollow tool handle so that the user can pick up the desired tool bit from the tool bit storage means. After picked up the desired tool bit from the tool bit storage means, the user must remove the previously used tool bit from the tool bit connector at the front side of the hollow tool handle and then attach the newly selected tool bit to the tool bit connector. This tool bit exchanging operation is complicated, wasting much time.

### SUMMARY OF THE INVENTION

The present invention has been accomplished under the circumstances in view. It is one object of the present invention to provide a hand tool, which has exchangeable tool bits stored therein for selection. It is another object of the present invention to provide a hand tool having exchangeable tool bits, which allows the user to change the tool bit conveniently.

To achieve these and other objects of the present invention, the hand tool comprises a base member, the base member having a front hole axially disposed at a front side thereof, a rear hole axially disposed at a rear side thereof, an accommodation open chamber located on a middle part thereof in communication between the front hole and the rear hole and a transversely extending side hole in communication with the rear hole; a rack set in the accommodation open chamber of the base member; a tool bit holder set in the rack and rotatable relative to the rack, the tool bit holder having a plurality of tool bit holes selectively set into axial alignment between the front hole and the rear hole of the base member; a set of tool bits respectively stored in the tool bit holes of the tool bit holder; a tool bit connector mounted in the front side of the base member, the tool bit connector having a tool bit outlet kept in axial alignment with the front hole of the base member; a grip, the grip having a push rod forwardly extended from a front side thereof and axially slidably inserted into the rear hole of the base member and movable with the grip relative to the base member to push one the tool bit out of the tool bit holder into the tool bit outlet of the tool bit connector, the push rod having a constricted portion near a front end thereof remote from the grip; a spring member mounted in the side hole of the base member; a retaining ring sleeved onto the push rod and supported on the spring member for engaging the constricted portion of the push rod to prohibit falling of the push rod out of the base member when the push rod is extended out of the base member; and a cap covering the side hole to hold the retaining ring inside the side hole.

### BRIEF DESCRIPTION OF THE DRAWINGS

FIG. 1 is an exploded view of a hand tool in accordance with the present invention.

FIG. 2 is an elevational assembly view of the hand tool in accordance with the present invention.

FIG. 3 is a schematic sectional view of the present invention, showing the grip moved apart from the base member and the push rod extended out of the base member.

FIG. 4 is a schematic sectional view of the present invention, showing the grip and the base member closely attached together and one tool bit extended out of the tool bit connector.

FIG. 5 is similar to FIG. 3, showing another the tool bit holder rotated to another angular position.

### DETAILED DESCRIPTION OF THE PREFERRED EMBODIMENT

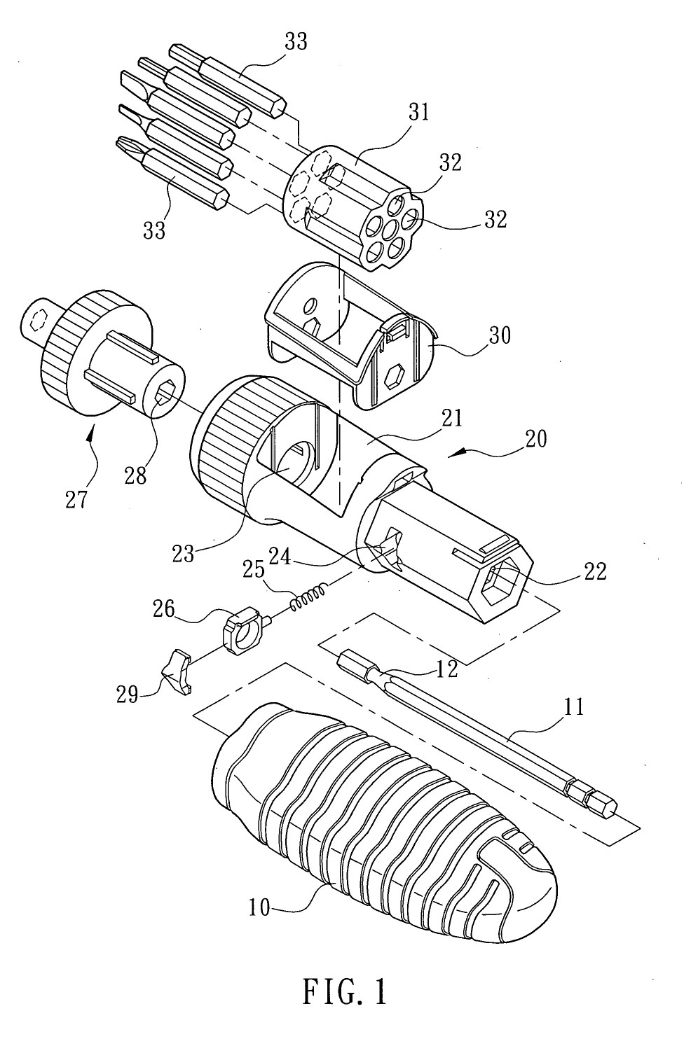

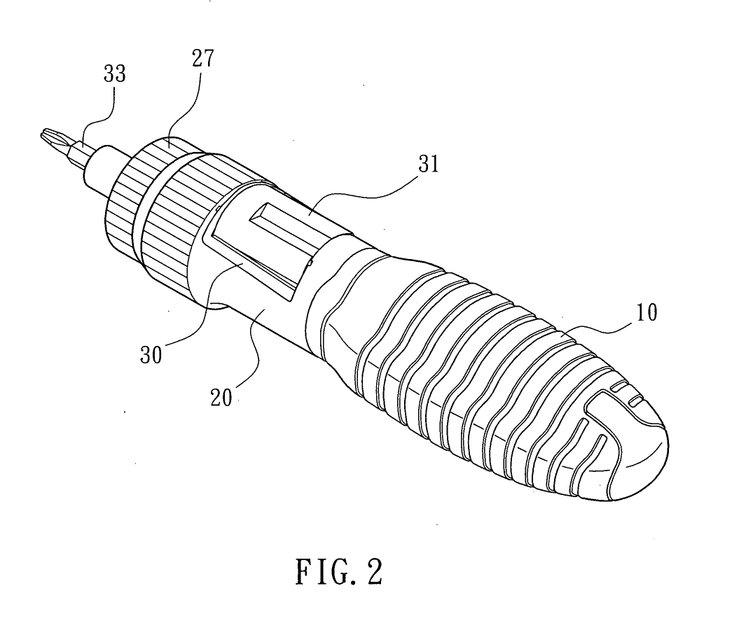

Referring to FIGS. 1-4, a hand tool in accordance with the present invention is shown comprising a grip 10, a base member 20, a rack 30, a tool bit holder 31 and a tool bit connector 27.

The grip 10 has a push rod 11 forwardly extended from the front side thereof. The push rod 11 has a constricted portion 12 near the distal end.

The base member 20 has an axially extending front hole 23, an axially extending rear hole 22, which receives the push rod 11, an accommodation open chamber 21 located on the middle in communication between the front hole 23 and the rear hole 22 for accommodating the rack 30 and a transversely extending side hole 24 in communication with the rear hole 22. Further, a spring member 25 is mounted in the side hole 24. Further, a retaining ring 26 is sleeved onto the push rod 11 and supported on the spring member 25 in the side hole 24. Further, a cap 29 covers the side hole 24 to hold the retaining ring 26 inside the side hole 24.

The rack 30 is accommodated in the accommodation open chamber 21 of the base member 20 for holding the tool bit holder 31.

The tool bit holder 31 has a plurality of tool bit holes 32 for accommodating different tool bits 33. Further, the tool bit holder 31 is set in the rack 30, and can be rotated in the rack 30 to let one of the tool bit holes 32 be selectively set into axial alignment with the front hole 23 and the rear hole 22. The tool bit connector 27 mounted in the front side of the base member 20, having a tool bit outlet 28 axially extending through the front and rear sides thereof and kept in axial alignment with the front hole 23.

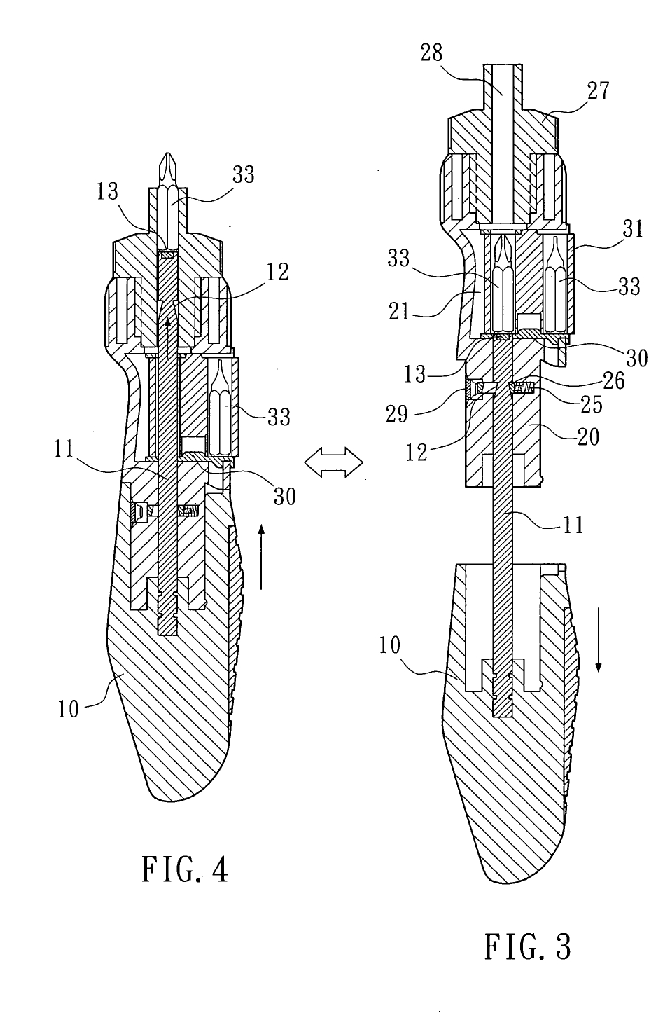

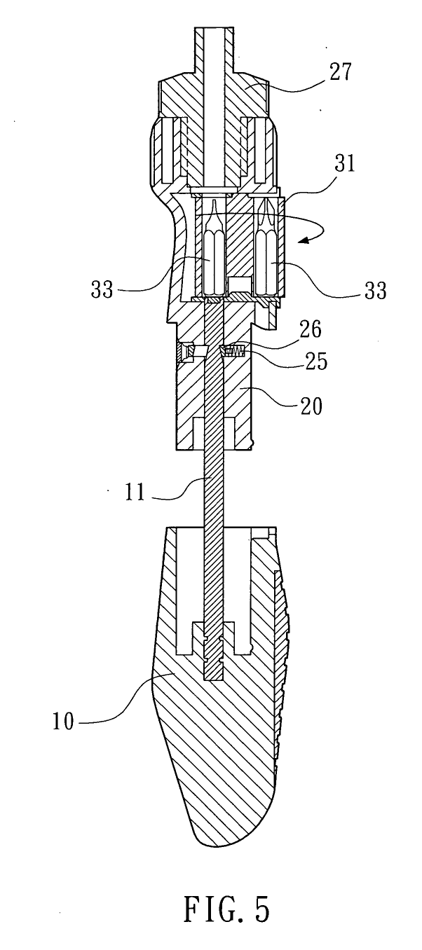

Referring to FIGS. 3 and 5, when using the hand tool, pull the grip 10 backwardly apart from the base member 20 (or pull the base member 20 forwardly apart from the grip 10) to move the push rod 11 out of the rack 30 and the tool bit holder 31, and then rotate the tool bit holder 31 in the rack 30 to move the selected tool bit 33 in one tool bit hole 32 into axial alignment between the front hole 23 and the rear hole 22, and then push the grip 10 forwardly toward the base member 20 to force the push rod 11 into the rack 30 and the tool bit holder 31, thereby pushing the selected tool bit 33 out of the respective tool bit hole 32 of the tool bit holder 31 into the front hole 23 of the base member 20 and the tool bit outlet 28 of the tool bit connector 27. Thus, when the grip 10 and the base member 20 are closely attached together, the selected tool bit 33 extends partially out of the front side of the tool bit outlet 28 of the tool bit connector 27 for working. Further, the push rod 11 has a magnet 13 embedded in the front side thereof (see FIGS. 3 and 4) that attracts the selected tool bit 33. When changing the tool bit 33, pull the grip 10 backwards relative to the base member 20 to move the extended tool bit 33 back into the respective tool bit hole 32 in the tool bit holder 31, and then rotate the tool bit holder 31 into the rack 30 to shift another tool bit 33 in one respective tool bit hole 32 into axial alignment between the front hole 23 and the rear hole 22.

Further, as shown in FIG. 3, the retaining ring 26 is constantly kept in an eccentric position subject to the spring force of the spring member 25. When the grip 10 is pulled apart from the base member 20 to extend the push rod 11 out of the base member 20, the retaining ring 26 is forced into engagement with the constricted portion 12 of the push rod 11, prohibiting the push rod 11 from falling out of the base member 20.

In conclusion, the invention provides a hand tool, which has advantages and features as follows:
1. Tool bits 33 are kept in the tool bit holder 31 avoiding losing.
2. Simply by means of rotating the tool bit holder 31, replacement of a different tool bit is done.
3. The retaining ring 26 is provided for engagement with the constricted portion 12 of the push rod 11, prohibiting the push rod 11 from falling out of the base member 20.
4. The tool bit holder 31 can be taken out of the rack 30 for changing all the storage tool bits conveniently.
5. The push rod 11 can be moved in and out of the base member 20 conveniently, facilitating the use of the hand too.

A prototype of hand tool has been constructed with the features of FIGS. 1-5. The hand tool functions smoothly to provide all of the features disclosed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A hand tool, comprising:
a base member, said base member having a front hole axially disposed at a front side thereof, a rear hole axially disposed at a rear side thereof, an accommodation open chamber located on a middle part thereof in communication between said front hole and said rear hole and a transversely extending side hole in communication with said rear hole;
a rack set in said accommodation open chamber of said base member;
a tool bit holder set in said rack and rotatable relative to said rack, said tool bit holder having a plurality of tool bit holes selectively set into axial alignment between said front hole and said rear hole of said base member;
a set of tool bits respectively stored in said tool bit holes of said tool bit holder;
a tool bit connector mounted in the front side of said base member, said tool bit connector having a tool bit outlet kept in axial alignment with said front hole of said base member;
a grip, said grip having a push rod forwardly extended from a front side thereof and axially slidably inserted into said rear hole of said base member and movable with said grip relative to said base member to push one said tool bit out of said tool bit holder into said tool bit outlet of said tool bit connector, said push rod having a constricted portion near a front end thereof remote from said grip;
a spring member mounted in said side hole of said base member;
a retaining ring sleeved onto said push rod and supported on said spring member for engaging said constricted portion of said push rod to prohibit falling of said push rod out of said base member when said push rod is extended out of said base member; and
a cap covering said side hole to hold said retaining ring inside said side hole.
